(19) United States
(12) Patent Application Publication
(10) Pub. No.: US 2026/0017588 A1
(43) Pub. Date: Jan. 15, 2026

(54) ARTIFICIAL INTELLIGENCE (AI) -ASSISTED IMAGE-BASED NETWORK MANAGEMENT, OPERATIONS, MAINTENANCE, PLANNING, AND DEPLOYMENT

(71) Applicant: Level 3 Communications, LLC, Denver, CO (US)

(72) Inventors: Priyadarshini Dande, Thornton, CO (US); Brian C. Ivester, Aurora, CO (US); Jason Thomas Saler, Hamburg, NY (US)

(73) Assignee: Level 3 Communications, LLC, Denver, CO (US)

(21) Appl. No.: 19/265,595

(22) Filed: Jul. 10, 2025

Related U.S. Application Data
(60) Provisional application No. 63/671,370, filed on Jul. 15, 2024.

(51) Int. Cl. G06Q 10/0631; G06F 3/14; G06V 10/44

(52) U.S. Cl. CPC G06Q 10/06316; G06F 3/14; G06V 10/44

(57) ABSTRACT

Novel tools and techniques are provided for implementing AI-assisted image-based network management, operations, maintenance, planning, and deployment. In examples, a computing system accesses at least one image of a network equipment that is used to provide network services in a network, the at least one image being captured at a location where the network equipment is physically connected to the network. The computing system causes extraction of one or more features from the at least one image, using at least one artificial intelligence (“AI”) model of an AI system, and causes generation of an output related to a network-based task to be performed on at least one of the network equipment or the network to which the network equipment is connected, using the at least one AI model. The computing system causes display of the output on a display device of a user device associated with a user.

### CROSS-REFERENCE TO RELATED APPLICATIONS

This application claims the benefit of priority to U.S. Provisional Application No. 63/671,370 filed Jul. 15, 2024, entitled “Artificial Intelligence (AI)-Assisted Image-Based Network Management, Operations, Maintenance, Planning, and Deployment,” which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing artificial intelligence (“AI”)-assisted image-based network management, operations, maintenance, planning, and deployment, and, more particularly, to methods, systems, and apparatuses for implementing AI-assisted image-based field technician task assistance and validation, network equipment discovery and inventory reconciliation, and network capacity planning.

### BACKGROUND

Network management, operations, maintenance, planning, and deployment is typically performed manually, with disparate or disjointed information stores containing data associated with such tasks. As the network grows or new equipment is added, managing the overall telecommunications system becomes unwieldy, inefficient, and subject to inaccuracies. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing AI-assisted image-based network management, operations, maintenance, planning, and deployment, in accordance with various embodiments.

FIG. 2 depicts another example system for implementing AI-assisted image-based network management, operations, maintenance, planning, and deployment, in accordance with various embodiments.

FIG. 2A depicts an example system for implementing AI-assisted image-based field technician task assistance and validation, in accordance with various embodiments.

FIG. 2B depicts an example system for implementing AI-assisted image-based network equipment discovery and inventory reconciliation, in accordance with various embodiments.

FIG. 2C depicts an example system for implementing AI-assisted image-based network capacity planning, in accordance with various embodiments.

FIGS. 3A and 3B depict various example user interfaces (“UIs”) that may be displayed on a mobile device associated with or used by a field technician when implementing AI-assisted image-based field technician task assistance and validation, in accordance with various embodiments.

FIG. 4 depicts a flow diagram illustrating an example method for implementing AI-assisted image-based network management, operations, maintenance, planning, and deployment, in accordance with various embodiments.

FIG. 4A depicts a flow diagram illustrating an example method for implementing AI-assisted image-based field technician task assistance, in accordance with various embodiments.

FIG. 4B depicts a flow diagram illustrating an example method for implementing AI-assisted image-based discovery and reconciliation of network equipment, in accordance with various embodiments.

FIG. 4C depicts a flow diagram illustrating an example method for implementing AI-assisted image-based network planning and design, in accordance with various embodiments.

FIGS. 5A-5C depict flow diagrams illustrating an example method for implementing AI-assisted image-based field technician task assistance and validation, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

As briefly discussed above, Network management, operations, maintenance, planning, and deployment is typically performed manually, with disparate or disjointed information stores containing data associated with such tasks. As the network grows or new equipment is added, managing the overall telecommunications system becomes unwieldy, inefficient, and subject to inaccuracies. In existing network infrastructures, discovery and reconciliation functions, task management functions, and network planning functions are wholly separate functions that are not integrated within a collective whole. This leads to further inefficiencies and inaccuracies in network inventory data for network equipment for providing network services in a network(s).

The present technology provides for AI-assisted image-based network management, operations, maintenance, planning, and deployment, and, more particularly, for AI-assisted image-based field technician task assistance and validation, network equipment discovery and inventory reconciliation, and network capacity planning, among other functions. In examples, AI-assisted image-based network management, operations, maintenance, planning, and deployment is implemented as an software application (“app”)-based tool to assist with network planning and installation of new network equipment, where it can be used to plan for the installation of hardware, to analyze the hardware after the installation is completed to confirm whether the hardware works and installation is performed correctly, and to provide instructions for any modifications to ensure correct installation, among other features and functions. The present technology also links field technician task assistance and validation, network equipment discovery and inventory reconciliation, and network capacity planning into a single integrated architecture that enables cross-referencing of information regarding network equipment in the networks under operation and control of the service provider. This improves on the efficiency of the individual network-based tasks, while ensuring accuracy of information regarding the network equipment across platforms for providing the network-based tasks (e.g., task management, network planning, discovery and reconciliation, field technician tasks, etc.). The AI system at the heart of the overall architecture links the various platforms, while providing platform-specific image analysis, feature extraction, recommendations, etc.

These and other aspects of the methods and systems for implementing the AI-assisted image-based network management, operations, maintenance, planning, and deployment are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n , and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method including accessing, by a computing system, at least one first image of a first network equipment that is used to provide network services in a network, the at least one first image being captured at a first location where the first network equipment is physically connected to the network; causing, by the computing system, extraction of one or more first features from the at least one first image, using at least one AI model of an AI system, the at least one AI model each being trained to perform computer vision tasks on an equipment type corresponding to the first network equipment; causing, by the computing system, generation of an output related to a first network-based task to be performed on at least one of the first network equipment or the network to which the first network equipment is connected, using the at least one AI model; and causing, by the computing system, display of the output on a display device of a user device associated with a first entity.

In another aspect, the technology relates to a system, including an AI system includes at least one first AI model trained to perform computer vision tasks and at least one second AI model trained to generate outputs related to network-based tasks; and a computing system. The computing system includes a processing system and memory coupled to the processing system. The memory including computer executable instructions that, when executed by the processing system, causes the system to perform operations including: accessing at least one first image of a first network equipment that is used to provide network services in a network, the at least one first image being captured at a first location where the first network equipment is physically connected to the network; causing extraction of one or more first features from the at least one first image, using the at least one first AI model of the AI system, the at least one first AI model each being trained to perform computer vision tasks on an equipment type corresponding to the first network equipment; causing generation of an output related to a first network-based task to be performed on at least one of the first network equipment or the network to which the first network equipment is connected, using the at least one second AI model; and causing display of the output on a display device of a user device associated with a first entity.

In yet another aspect, the technology relates to a method, including sending, by a computing system and to a first mobile device associated with a first technician, first instructions that cause the first mobile device to display, on a display device of the first mobile device, first information associated with a first technician task to be performed on a first network equipment by the first technician; receiving, by the computing system and from the first mobile device, one or more images of the first network equipment that are captured and uploaded via the first mobile device; causing, by the computing system, computer vision processing, using at least one AI model of an AI system, to identify one or more features in the one or more images of the first network equipment; causing, by the computing system, generation of a task guidance and feedback output based on the first technician task to be performed on a first network equipment by the first technician and based on information regarding the first network equipment and regarding where the first network equipment is physically connected to a network as derived from the one or more first features extracted from the one or more images, using the at least one AI model; and causing, by the computing system, display of the task guidance and feedback output on the display device of the first mobile device associated with the first technician.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

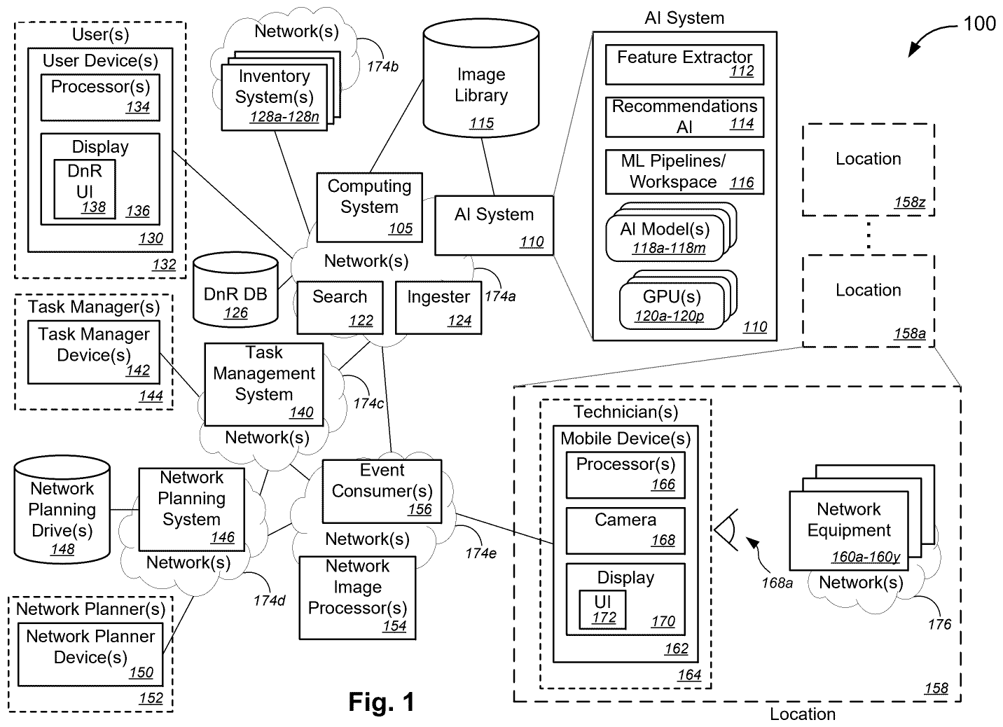

Turning to the embodiments as illustrated by the drawings, FIGS. 1-6 illustrate some of the features of methods, systems, and apparatuses for implementing AI-assisted image-based network management, operations, maintenance, planning, and deployment, and, more particularly, to methods, systems, and apparatuses for implementing AI-assisted image-based field technician task assistance and validation, network equipment discovery and inventory reconciliation, and network capacity planning, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts an example system 100 for implementing AI-assisted image-based network management, operations, maintenance, planning, and deployment, in accordance with various embodiments.

In the example of FIG. 1, system 100 includes a computing system 105, an AI system 110, and an image library 115. In examples, the AI system 110 may include a feature extractor 112, a recommendations AI 114, a machine learning (“ML”) workspace or ML pipelines 116, a plurality of AI models 118a-118m (collectively, “AI models 118” or the like), a plurality of graphics processing units (“GPUs”) 120a-120p (collectively, “GPUs 120” or the like), and/or the like. System 100 may further include a search utility 122, an ingester 124, a discovery and reconciliation (“DnR”) database(s) 126, one or more inventory systems 128a-128n (collectively, “inventory systems 128” or the like), a user device(s) 130 associated with or used by a user(s) 132, and/or the like. In some instances, the user device(s) 130 may include a processor(s) 134 and a display 136, and a DnR UI 138 may be displayed on the display 136. System 100 may further include a task management system 140, a task manager device(s) 142 associated with or used by a task manager(s) 144, and/or the like. In examples, system 100 may further include a network planning system 146, a network planning drive(s) 148, and a network planner device(s) 150 associated with or used by a network planner(s) 152, and/or the like. System 100 may further include a network image processor(s) 154 and an event consumer(s) 156.

At each of a plurality of locations 158a-158z (collectively, “locations 158” or the like), a plurality of network equipment 160a-160y (collectively, “network equipment 160” or the like) may be disposed, located, mounted, and/or connected to a network(s) (such as network(s) 176). In some examples, the plurality of network equipment 160 may include at least one of one or more servers, one or more gateway devices, one or more switches, one or more routers, one or more bridges, one or more hubs, one or more multiplexers, one or more demultiplexers, one or more network interface controllers, one or more modems, one or more firewalls, one or more network address translators, one or more access points, one or more repeaters, and/or one or more adapters, and/or the like. In examples, each location 158 is one of a data center, a central office, a field location, or a customer premises, or the like. A technician(s) 164, who is performing technician tasks involving the network equipment 160 at the location(s) 158, may use a mobile device(s) 162 (which may be associated with the technician(s) 164). In some cases, the technician tasks may include installing, deinstalling, reformatting, repairing, connecting/reconnecting, moving, and/or performing maintenance on network equipment, and/or connecting/reconnecting or reassigning components (e.g., slots, ports, or connectors, etc.) of the network equipment, and/or the like. In some instances, the mobile device(s) 162 may include a processor(s) 166, a camera 168, and a display 170, and a UI 172 may be displayed on the display 170. The camera 168, having a field of view (“FOV”) 168a is used to capture images of the network equipment 160 at the location(s) 158, in some cases, before, during, and/or after performing the technician tasks on the network equipment 160. Herein, m, n, p, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some instances, the computing system 105, AI system 110, image library 115, search utility 122, ingester 124, and DnR database(s) 126 may be disposed or located in, or otherwise connected to, network(s) 174a. In some cases, the inventory system(s) 128a-128n may be disposed or located in, or otherwise connected to, network(s) 174b. In some examples, the task management system 140 may be disposed or located in, or otherwise connected to, network(s) 174c. In examples, the network planning system 146 and the network planning drive(s) 148 may be disposed or located in, or otherwise connected to, network(s) 174d. In some instances, the network image processor(s) 154 and the event consumer(s) 156 may be disposed or located in, or otherwise connected to, network(s) 174c. In other examples, these components of system 100 may be disposed or located in, or otherwise connected to, any of these network(s) 174a-174c, and in some cases, two or more of networks 174a-174e may be combined or each of one or more of networks 174a-174e may be implemented as multiple networks. In examples, two or more (or all) of networks 174a-174c may be communicatively coupled with each other. In an example, network(s) 176 may be communicatively coupled with one or more of networks 174a-174c. In another example, network(s) 176 may be separate from any of networks 174a-174c, and, in some cases, may be communicatively coupled to a different network(s) that is not connected to any of networks 174a-174c.

According to some embodiments, networks 174a-174c and 176 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 174a-174e and 176 may include an access network of the service provider (e.g., an Internet service provider (“ISP”)). In another embodiment, the networks 174a-174c and 176 may include a core network of the service provider and/or the Internet.

In some examples, the computing system 105 includes one of a DnR computing system, a task management system, a network planning and design computing system, a network operations center (“NOC”) computing system, a network service provisioning system, a technician task assistance system, a network maintenance and troubleshooting system, a network security system, a network image processing system, a system orchestrator, a server, a cloud computing system, or a distributed computing system, and/or the like. In some instances, the AI system 110 may be based on language models (e.g., small language models (“SLMs”), large language models (“LLMs”), or other language models, etc.), on non-language models (e.g., convolutional neural networks (“CNNs”), recurrent neural networks (“RNNs”), deep neural networks (“DNNs”), transformers, and/or long short-term memory networks (“LSTMs”), etc.), on multimodal models capable of utilizing one or a combination of text, image, audio, or video as input and/or output.

In examples, the feature extractor 112 identifies and extracts relevant features from raw data (in this case image data that is compiled and stored in the image library 115, or the like), a relevant feature being an individual measurable property within a dataset, in this case, image-related features that are extracted using image processing techniques, text recognition, pattern recognition, etc. In examples, features that are extracted from images of each network equipment may include information including at least one of a manufacturer, a type, a device name, a device ID, a model number, version information, a capacity, a number of operational components, a number of failed or failing components, a number of used components, or a number of unused components of that network equipment, and/or the like. As used herein, components include at least one of slots, ports, or connectors, and/or the like. In some examples, the features further include a shelf ID for a shelf of an equipment rack on which each network equipment is mounted, rack information for the equipment rack, slot positions on each shelf used by which network equipment, a number of used equipment racks, a number of unused equipment racks, a number of used shelves on each equipment rack, a number of unused shelves on each equipment rack, a number of used slots on each shelf, or a number of unused slots on each shelf, and/or the like.

In some examples, the recommendations AI 114 may be a language-model-based AI that receives, as input, information regarding expected or projected network service usage, information regarding current capacity and current status of operation of the plurality of network equipment (e.g., as derived from features extracted from the image library), and provides, as output, recommendations related to network capacity planning. Examples of such recommendations may include recommendations to order new network equipment, to deploy and install the new network equipment in particular locations and/or connected to particular networks or network interfaces, to perform network grooming, to perform reallocation of network equipment, and/or to perform reassignment of components (e.g., slots, ports, or connectors, and/or the like) of network equipment, and/or the like. As used herein, network grooming refers to a process of reassigning connections or ports, rerouting paths, grouping a number of smaller telecommunications flows into larger flows, replacing equipment assignments, conducting traffic-flow type changes, and/or other optimization processes. In examples, the recommendations AI 114 may also be used to provide recommendations related to network-based tasks to be performed by the technicians 164, as part of AI-assistance for the task management system 140. In some instances, ML pipelines, as used herein, refer to independently executable workflows for performing an ML task, the workflows being automated by enabling data to be transformed and correlated into a model that is analyzed to produce outputs. In some cases, ML workspace, as used herein, refers to a central or integrated development environment that is configured and specialized for ML pipelines and ML workflows. In some examples, as used herein, an AI model refers to a program that is designed to replicate human intelligence, by applying algorithms to data to recognize patterns, make predictions, make decisions, and/or conduct actions without human intervention. In examples, the plurality of AI models 118a-118m includes one or more first AI models trained to perform the computer vision tasks and one or more second AI models trained to generate outputs related to the network-based tasks. In some examples, the GPUs 120a-120p are used by the AI system 110 to perform processing for the AI/ML tasks.

In some cases, the image library 115 is a data repository, data lake, or blob storage that contains a plurality of images of a plurality of network equipment (e.g., the plurality of network equipment 160a-160y, and/or the like) that is used to provision network services in a network (e.g., network(s) 176). In an example, the image library 115 is part of the AI system 110. In other examples, the image library 115 is external to, yet communicatively coupled to (and accessible by), the AI system 110. In some examples, the image library contains at least one of: (1) images of one or more network equipment that are captured and uploaded by field technicians during truck rolls; (2) images of one or more network equipment that are captured and uploaded by field technicians during site surveys; (3) images of one or more network equipment that are captured and uploaded by field technicians during maintenance, troubleshooting, or repair operations; (4) images of one or more network equipment that are captured and uploaded by field technicians during network equipment installation, provisioning, decommissioning, or grooming operations; (5) images of one or more network equipment that are captured and uploaded by field technicians during equipment audits; or (6) images of one or more network equipment that are uploaded from one or more data storage systems by service provider agents; and/or the like. In examples, additional images (using various cameras, viewing angles, and/or lighting conditions) may be added to the image library 115 to expand image recognition functionality of the AI system 110 to more devices. In some examples, personally identifiable information (“PII”), controlled unclassified information (“CUI”), or other sensitive data are removed from the images, prior to storage of the images in the image library, and images in the image library are securely stored.

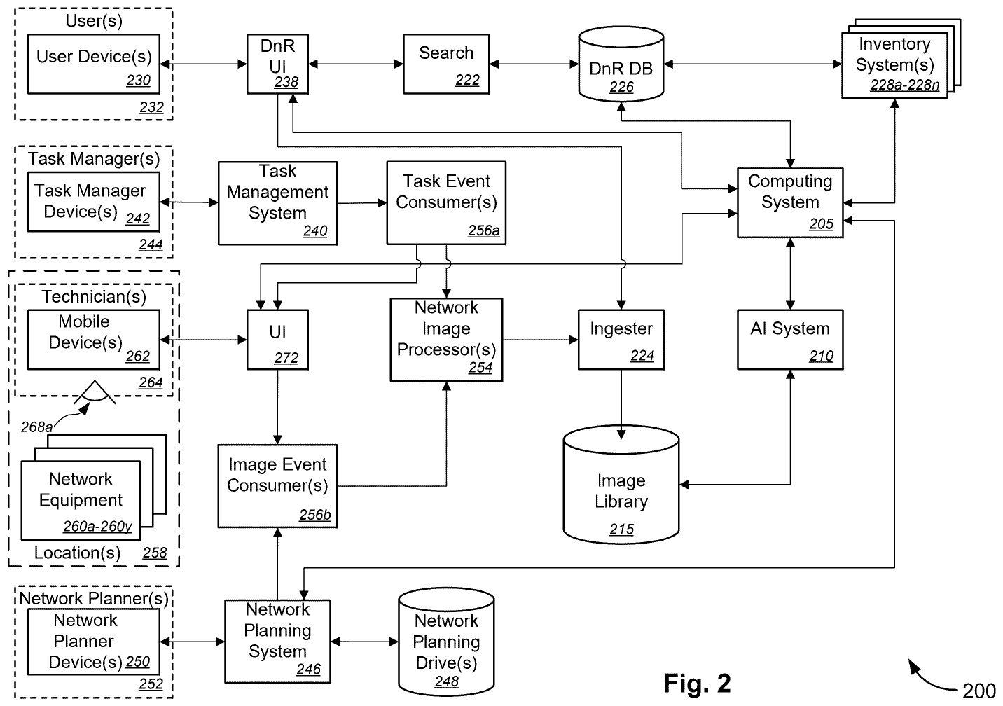

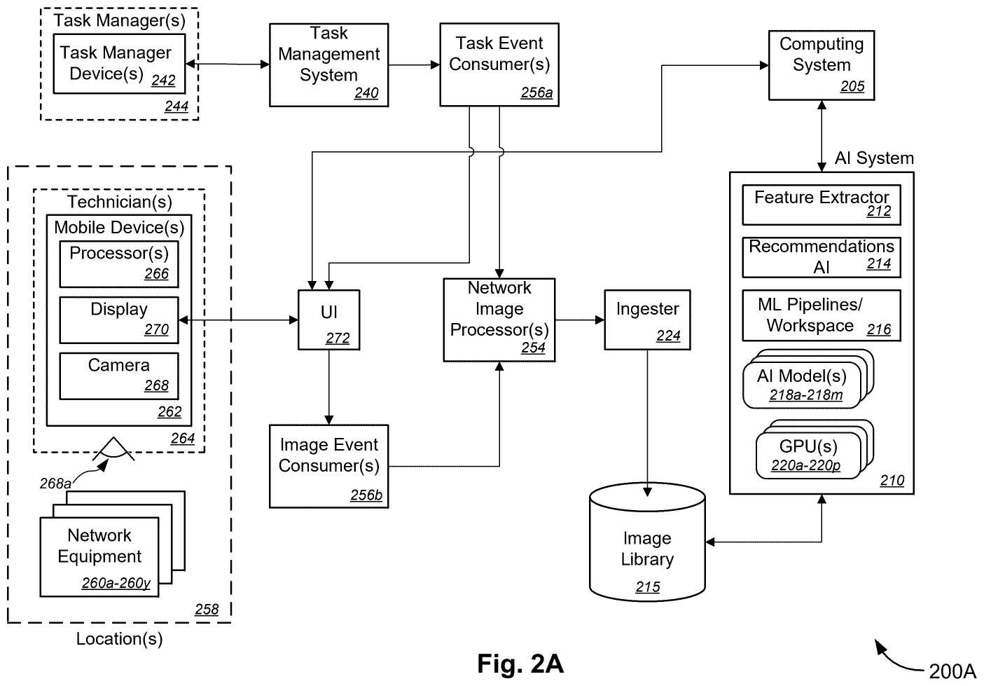

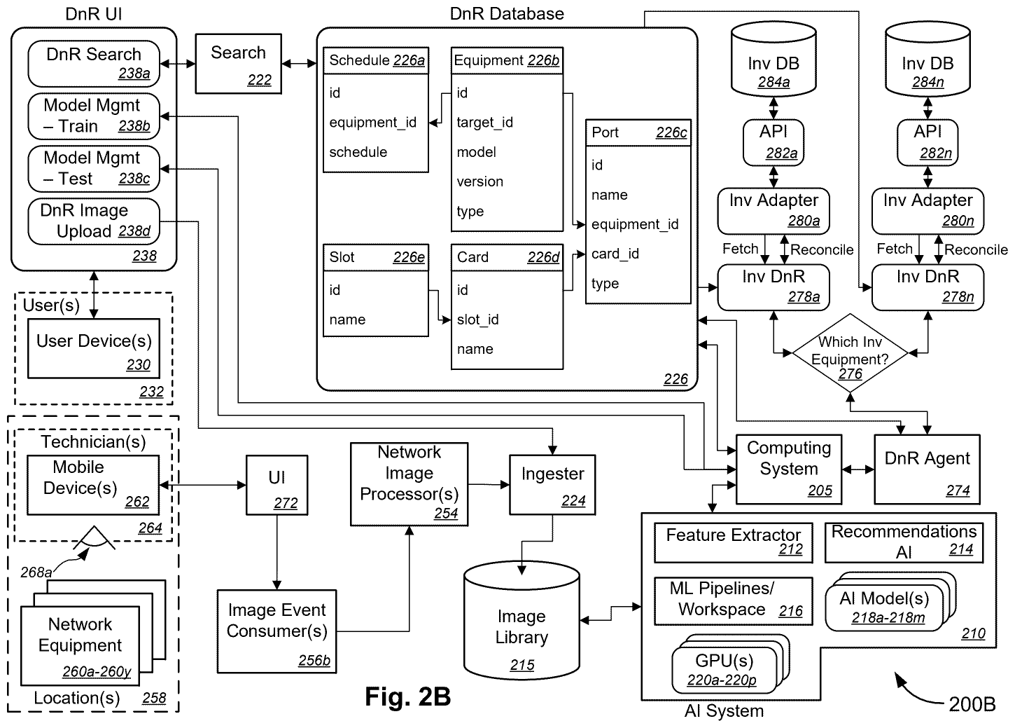

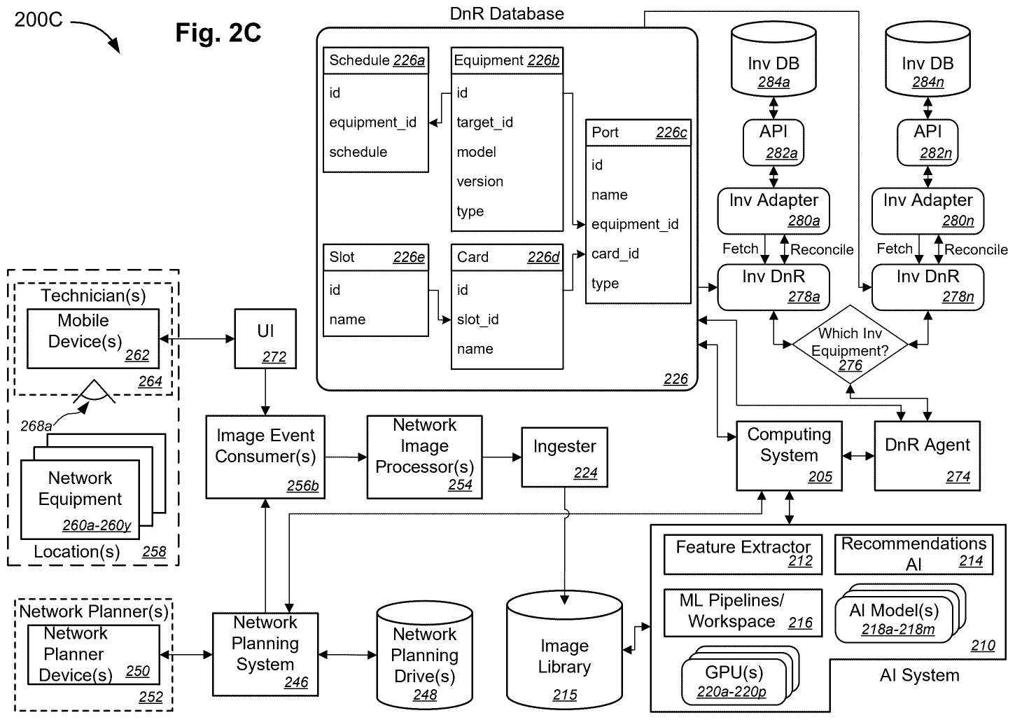

In some instances, the search utility 122 is used to search the DnR database(s) 126 and to retrieve or fetch DnR details from the DnR database(s) 126. In some cases, the ingester 124 is used to receive, collect, and/or process images that are captured, uploaded, or otherwise transferred for storage in the image library. In some instances, the ingester 124 may also resize and/or reformat image files, and may, in some cases, also process and extract metadata from image files. In examples, the inventory system(s) 128a-128n is used to track the inventory of network equipment across the plurality of locations 158a-158z and/or connected to network(s) 176, and is described in greater detail with respect to inventory system components 276, 278a-278n, 280a-280n, 282a-282n, and 284a-284n as shown in FIGS. 2B and 2C. The task management system 140 and the task manager device(s) 142 are used to monitor, track, and assign network-based tasks. The network planning system 146 and network planner device(s) 150 are used to enable network planning operations. The network image processor(s) 154 is used to process image files prior to ingestion by the ingester 124. The event consumer(s) 156 (including a task event consumer(s) 256a and an image event consumer(s) 256b, such as shown, e.g., in FIG. 2) ingests (either in real-time or in a later relevant instance) tasks from the task management system 140 or images from the network planning system 146 and/or the UI 172/mobile device(s) 162, and processes the tasks or images to trigger another action, workflow, or another event, in some cases, prior to transfer to (and processing by) the network image processor(s) 154.

In examples, the user device(s) 130, the task manage device(s) 142, and the network planner device(s) 150 may each include at least one of a tablet computer, a laptop computer a desktop computer, a workstation console, a smartphone, or a mobile phone, and/or the like. In some examples, the mobile device(s) 162 may include at least one of a tablet computer, a laptop computer, a smartphone, or a mobile workstation, and/or the like, each with either an integrated camera and/or an externally connected camera (that serves as camera 168).

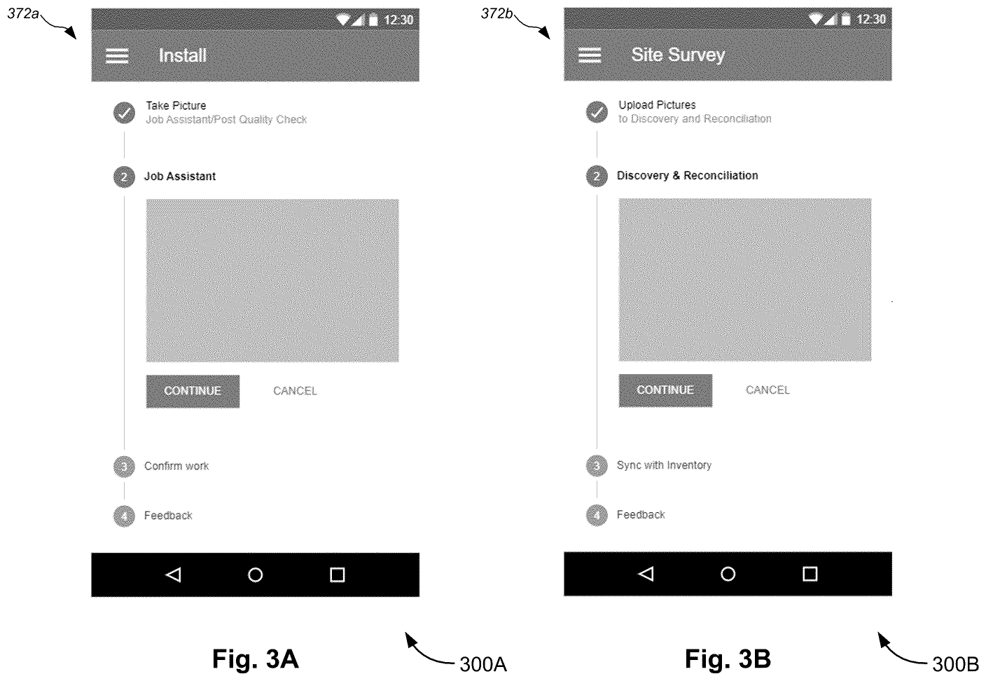

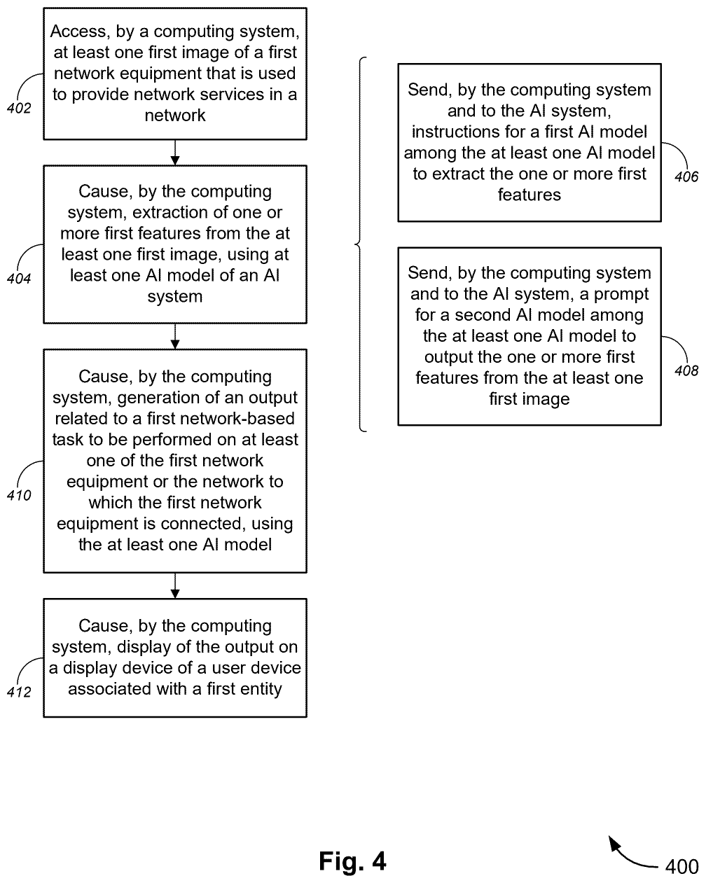

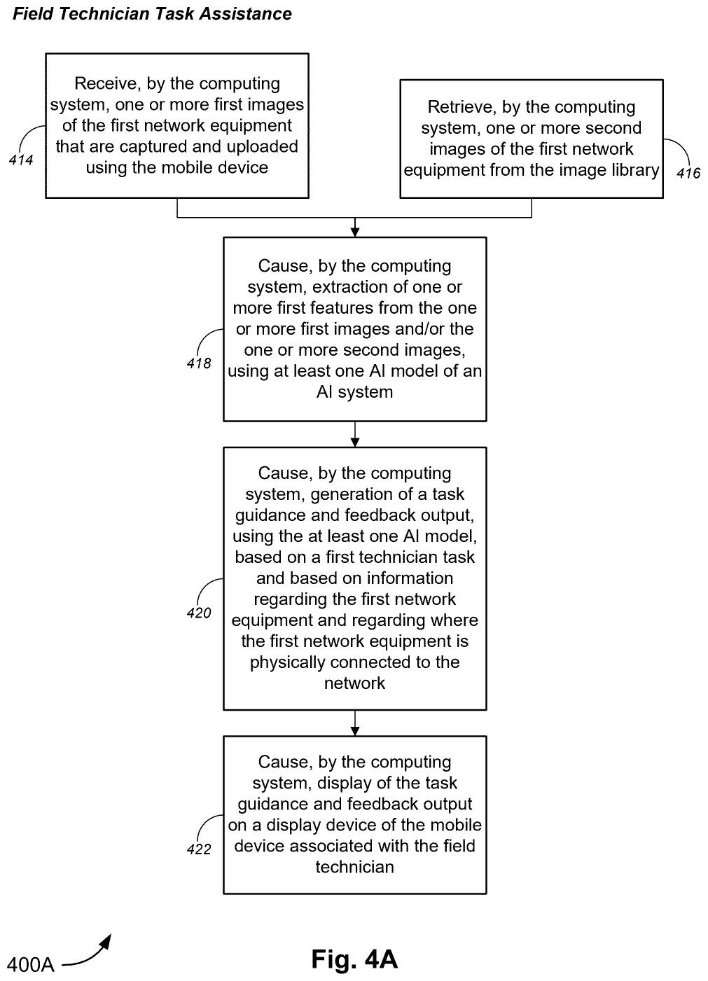

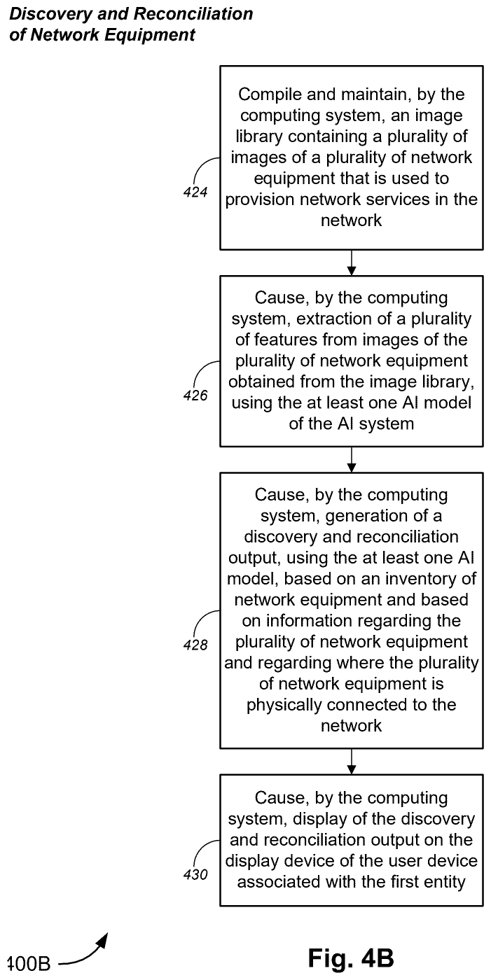

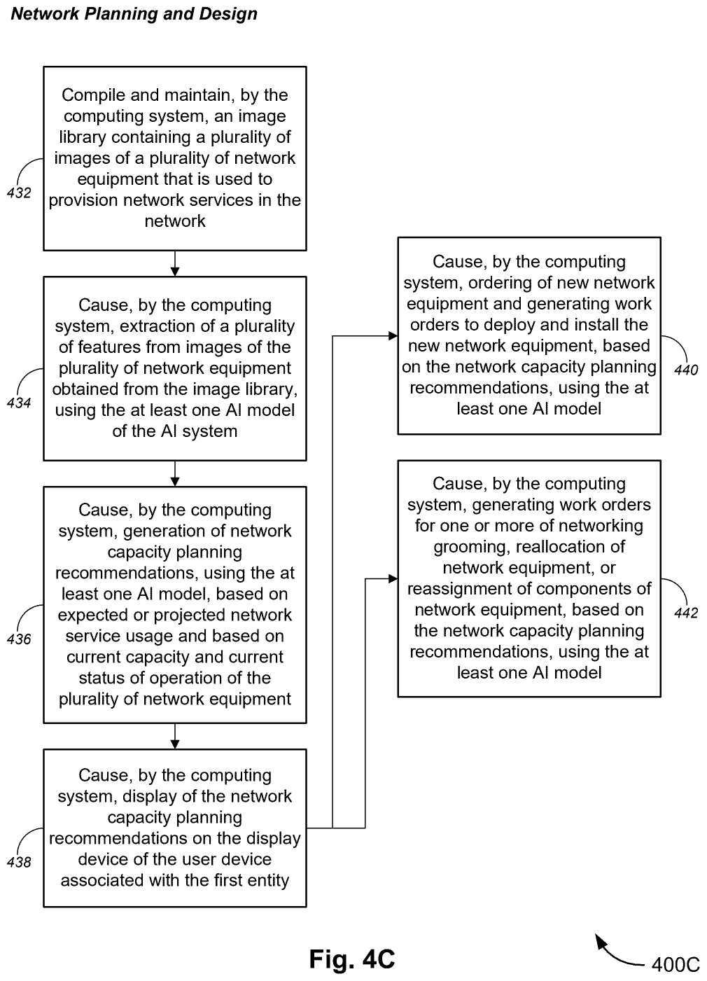

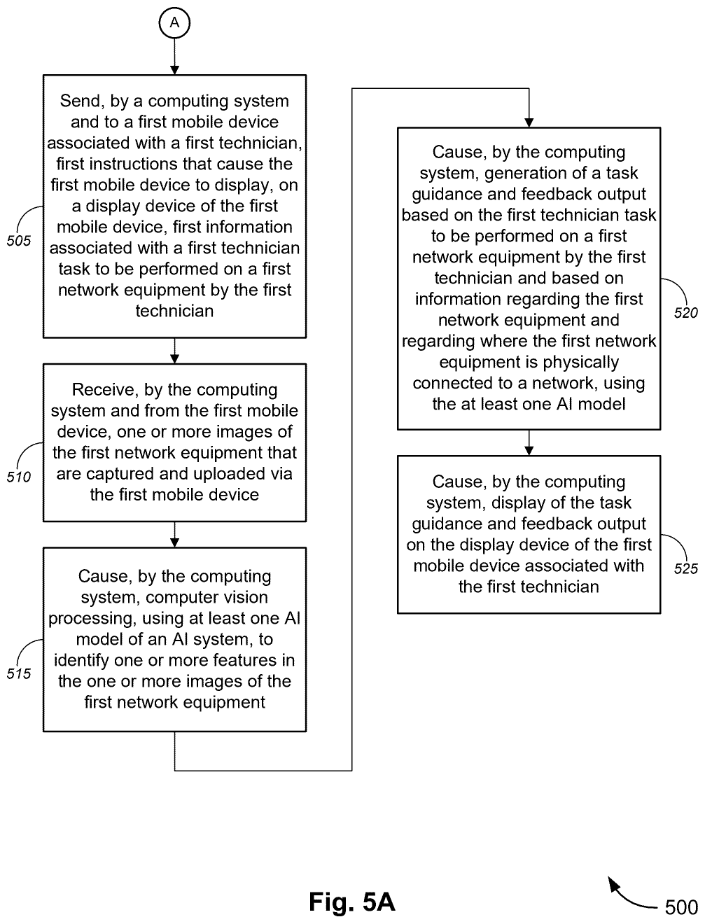

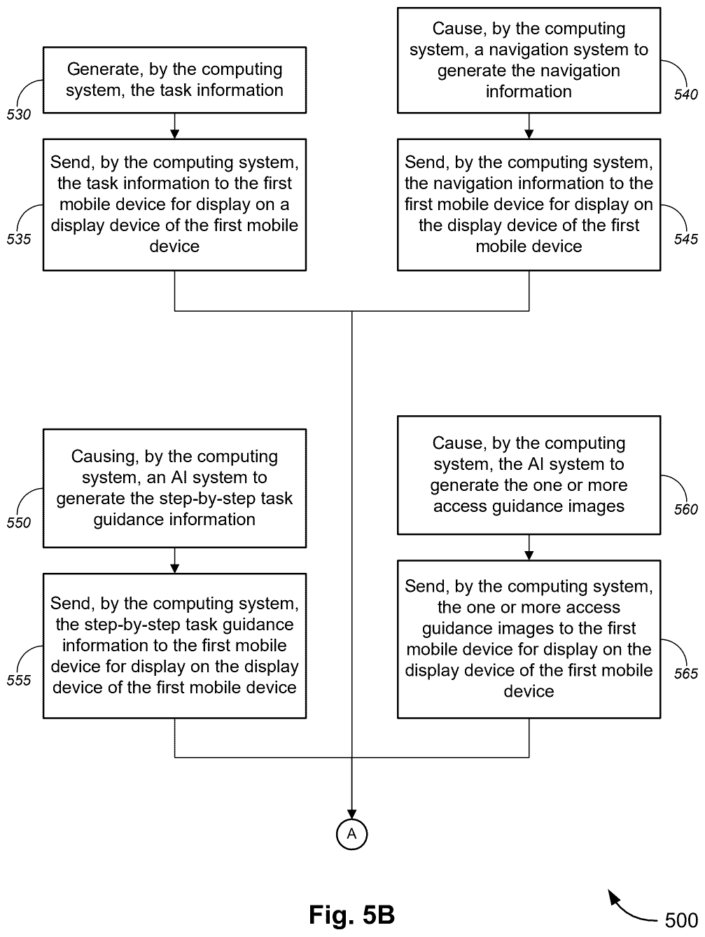

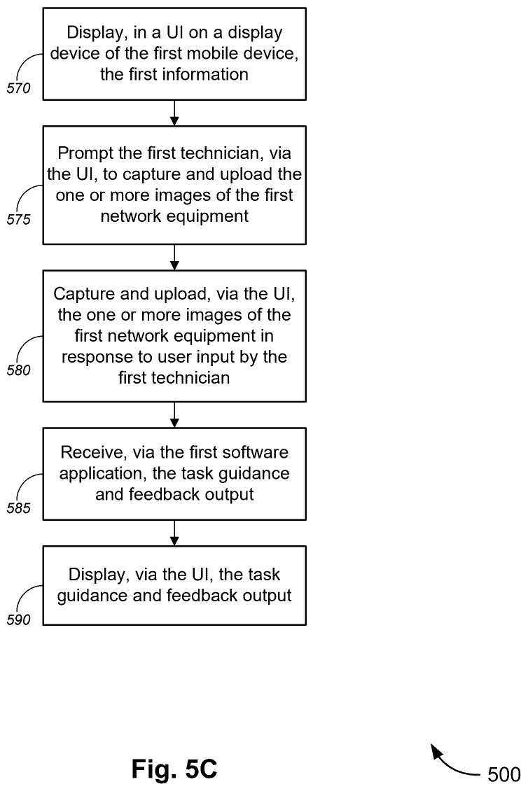

In operation, computing system 105 and/or the AI system 110 may perform methods for implementing AI-assisted image-based network management, operations, maintenance, planning, and deployment, as described in detail with respect to FIGS. 2-5. For example, the example systems 200 and 200A-200C as described below with respect to FIGS. 2 and 2A-2C, the example UIs 300A and 300B as described below with respect to FIGS. 3A and 3B, and the example methods 400, 400A-400C, and 500 as described below with respect to FIGS. 4, 4A-4C, and 5, respectively, may be applied with respect to the operations of system 100 of FIG. 1. In examples, the AI-assisted image-based network management, operations, maintenance, planning, and deployment may be implemented via an app through which the UIs (e.g., DnR UI 138, UI 172, etc.) are displayed.

FIG. 2 depicts another example system 200 for implementing AI-assisted image-based network management, operations, maintenance, planning, and deployment, in accordance with various embodiments. FIG. 2A depicts an example system 200A for implementing AI-assisted image-based field technician task assistance and validation, in accordance with various embodiments. FIG. 2B depicts an example system 200B for implementing AI-assisted image-based network equipment discovery and inventory reconciliation, in accordance with various embodiments. FIG. 2C depicts an example system 200C for implementing AI-assisted image-based network capacity planning, in accordance with various embodiments. While FIG. 2 depicts an overall map interconnecting the various components of the system 200 and the directions of information flow, each of FIGS. 2A-2C depicts a subsystem 200A-200C, respectively, that highlight connections among the various components for performing specific network-based tasks (e.g., field technician task assistance and validation, equipment discovery and inventory reconciliation, or network capacity planning, etc.). Although particular subsystems and network-based tasks are specifically described herein, the various embodiments are not so limited, and any suitable configuration/subsystem of components of system 200 and any corresponding network-based tasks may be used or implemented.

In some embodiments, computing system 205, AI system 210, feature extractor, 212, recommendations AI 214, ML Pipelines or workspace 216, AI models 218a-218m, search utility 222, ingester 224, DnR database(s) 226, inventory systems 228a-228n, user device 230, user 232, processor(s) 234, display 236, UI 238, task management system 240, task manager device 242, task manager 244, network planning system 246, network planning drive 248, network planner device 250, network planner 252, network image processor 254, task event consumer 256a or image event consumer 256b, location(s) 258, network equipment 260a-260y, mobile device 262, technician 264, processor(s) 266, camera 268 and FOV 268a, display 270, and UI 272, of FIGS. 2 and 2A-2C may be similar, if not identical, to the computing system 105, AI system 110, feature extractor, 112, recommendations AI 114, ML Pipelines or workspace 116, AI models 118a-118m, search utility 122, ingester 124, DnR database(s) 126, inventory systems 128a-128n, user device 130, user 132, processor(s) 134, display 136, UI 138, task management system 140, task manager device 142, task manager 144, network planning system 146, network planning drive 148, network planner device 150, network planner 152, network image processor 154, event consumer 156, locations 158 and 158a-158z, network equipment 160a-160y, mobile device 162, technician 164, processor(s) 166, camera 168 and FOV 168a, display 170, and UI 172, respectively, of system 100 of FIG. 1, and the description of these components of system 100 of FIG. 1 are similarly applicable to the corresponding components of FIGS. 2 and 2A-2C.

With reference to FIG. 2, a user device(s) 230 associated with or used by user(s) 232 interacts with a DnR UI 238 to perform search of a DnR database(s) 226 using search utility 222. The DnR database(s) 226 and the inventory system(s) 228a-228n are both updated (and, in some cases, at least partially synchronized with respect to corresponding data stored on each type of database system), using computing system 205. The DnR UI 238 also interacts with AI system 210, in some cases, via computing system 205. DnR UI 238 also enables uploading of images (in some cases, in bulk), and the uploaded images are ingested by ingester 224, prior to storage in image library 215, from which the AI system 210 accesses images to perform AI/ML tasks (e.g., feature extraction, image analysis, guidance generation, recommendations, etc.). In examples, task manager device(s) 242 associated with or used by task manager(s) 244 interacts with task management system 240 to output tasks (e.g., technician tasks) to be performed by technician(s) 264 on network equipment 260a-260y at location(s) 258. The task event consumer(s) 256a consumes tasks output by the task management system 240 and sends the tasks to UI 272 that is displayed on a display of mobile device(s) 262, which is associated with or used by technician(s) 264. In some instances, images contained in the tasks are sent to network image processor(s) 254 for image processing prior to ingestion by ingester 224 and storage in image library 215. Technician(s) 264 uses mobile device(s) 262 to capture images of network equipment 260a-260y that are within FOV 268a of a camera of the mobile device(s) 262, and sends the captured images of the network equipment 260a-260y, via UI 272, to image event consumer(s) 256b. The network planner device(s) 250 associated with or used by network planner(s) 252 interacts with network planning system 246 and/or network planning drive(s) 248 to send images generated or otherwise outputted by network planning system 246 to the image event consumer(s) 256b. The image event consumer(s) 256b sends images from UI 272 and/or images from network planning system 246 to the network image processor(s) 254 for image processing prior to ingestion by ingester 224 and storage in image library 215. In some cases, the network planning system 246 interacts with computing system 205 to access information stored in the DnR database(s) 226 and/or the inventory system(s) 228a-228n when performing network planning operations.

In some aspects, the system provides access to images from the image library, from a site survey team(s), from a technician(s), etc. In examples, the AI system 210 performs image segmentation, labeling, versioning, and storing, and feature extraction is performed based on image segmentation and labeling. In some examples, the AI system 210 trains the AI model(s) 218a-218m to perform AI/ML image recognition to identify image features, including, but not limited to: (I) Identifying chassis type and slot name/AID/position; (II) Identifying specific card models and the slots they occupy; (III) Identifying ports in cards (and numbering the ports properly and identifying whether the ports are consumed or empty; (IV) Identifying indicator lights in the images and updating modeled attributes with the state or status indicated; (V) Identifying text in images and including text information in modeled attributes; (VI) Enabling image annotation and managing image metadata; and (VII) Provide feedback functionality from end-users (e.g., user(s) 232, task manager(s) 244, technician(s) 264, network planner(s) 252, etc.) for improving image quality; and/or the like. In examples, the UI 272, the DnR UI 238, and/or other interfaces may be deployed to perform functions, including, but not limited to: (A) showing whether inventory data matches the captured images of the network equipment, and to highlight any discrepancies; (B) Enabling users to search for specific equipment and applying filters to narrow the results; (C) Displaying uploaded images and results of image analysis; (D) Enabling addition or modification of tags for images for each piece of equipment (which improves the accuracy of the system over time); (E) Providing a feedback mechanism integrated into the UI to allow users to report inaccuracies in the image analysis and/or to provide valuable data that can be used to further train and improve the AI model; and/or the like.

In examples, the system is a multi-level classification system that categorizes images by equipment type, model, and configuration. A labeling system is used that adapts to new equipment types and technological updates. In some examples, a semantic labeling system is implemented to align classification details with databases or indexed models of equipment. In an example, the semantic labeling system uses ontology-based labels that define relationships between different equipment types and their attributes, and, in some cases, reflects this ontology by linking images directly to database entries, or the like. In some instances, the semantic labeling system may employ attribute-value pairs, where each label includes an attribute (e.g., ‘port type’) and its value (e.g., ‘RJ45’), corresponding to the structure of the database entries. In some cases, the semantic labeling system may assign cross-referencing identified, where unique identifiers for each label matches identifiers used in the database for easy cross-referencing. In examples, the semantic labeling system may implement hierarchical decomposition, where the system starts with broad categories and narrows down to specific details, mirroring the decomposition of equipment into subcomponents. In some examples, the semantic labeling system may enable dynamic label generation to ensure that the system is capable of generating new labels as new equipment configurations are added to the database.

In various aspects, for audit functions, images may be securely stored that show details that are not stored in the inventory database, such as details regarding security of the rack, previously incorrected hookup, setup, and/or configuration (e.g., wrong port previously used, etc.), equipment not listed in inventory, etc. To expand the image recognition.

Referring to the example system 200A of FIG. 2A, an example implementation of AI-assisted image-based field technician task assistance and validation may be as follows. In examples, task manager(s) 244 utilizes task manager device(s) 242 to interact with task management system 240 to output technician tasks to be performed by technician(s) 264 on network equipment 260a-260y at location(s) 258. In some examples, the task management system 240 may autonomously assign technician tasks based on triggers (e.g., delivery of network equipment, parts, components, etc.; system alerts regarding failing or unresponsive network equipment; etc.). The task event consumer(s) 256a consumes tasks output by the task management system 240 and sends the tasks to UI 272 that is displayed on display 270 of mobile device(s) 262. In some instances, images contained in the tasks are sent to network image processor(s) 254 for image processing prior to ingestion by ingester 224 and storage in image library 215.

In examples, task information for the technician task is displayed in display 270, via UI 272. In some examples, navigation information to guide the technician(s) 264 to a location 258 of the network equipment 260 may also be displayed in display 270, via UI 272. Alternatively or additionally, step-by-step task guidance information including at least one of image-based guidance, audio-based guidance, video-based guidance, text-based guidance, or text-to-speech-based guidance, and/or the like, for performing the first technician task may be displayed in display 270, via UI 272. In some cases, at least one image contained in the image-based guidance or the video-based guidance may be based on at least one of one or more previously captured images of the network equipment, one or more stock images of network equipment that are of a same type or model as the network equipment, or an AI-generated mock image of network equipment that is similar to the network equipment, and/or the like. Alternatively or additionally, one or more access guidance images for accessing one or more portions of the first network equipment prior to performing the first technician task may include may be displayed in display 270, via UI 272.

Technician(s) 264 uses camera 268 of mobile device(s) 262 to capture images of network equipment 260a-260y that are within FOV 268a of camera 268, in some cases, prior to, during, and/or after performing the technician tasks. The processor(s) 266 of mobile device(s) 262 causes the captured images of the network equipment 260a-260y to be sent, via UI 272, to image event consumer(s) 256b. In some examples, in areas with limited or no wireless network or cellular network connection, the images may be held by the mobile device 262 (in local storage) until sufficient network connectivity signal (e.g., for a Wi-Fi network(s) and/or a cellular network(s)) has been obtained, and the images are sent (or published) once the mobile device 262 is connected to the wireless network or cellular network. The image event consumer(s) 256b consumes and sends images from UI 272 to the network image processor(s) 254 for image processing prior to ingestion by ingester 224 and storage in image library 215.

The AI system 210 uses feature extractor 212 to extract features from the captured images of the network equipment 260a-260y. In examples, the features that are extracted from the captured images include, for each network equipment, at least one of a manufacturer, a type, a device name, a device ID, a model number, version information, a capacity, a number of operational components, a number of failed or failing components, a number of used components, or a number of unused components of that network equipment, and/or the like. In some examples, the features that are extracted may further include one or more of a shelf ID for a shelf of an equipment rack on which that network equipment is mounted, rack information for the equipment rack, a slot position on the shelf that is being used by that network equipment, or other slot positions on the shelf that are being used by other network equipment. and/or the like. The AI system 210 uses the GPUs 220a-220p to perform processing for AI/ML tasks utilizing computer vision-based AI models among the AI models 218a-218m, within ML pipelines or workspace 216, to assist the feature extractor 212 in extracting the features described above. The AI system 210 uses the GPUs 220a-220p to perform processing for AI/ML tasks utilizing generative AI models among the AI models 218a-218m, within ML pipelines or workspace 216, to assist the recommendations AI 214 to generate the navigation information, the step-by-step task guidance information, and/or the one or more access guidance images (collectively, “pre-task guidance”), and/or to generate a task guidance and feedback output, in some cases, based on the technician task to be performed on the network equipment by the technician(s) 264 and based on information regarding the network equipment and regarding where the network equipment is physically connected to the network as derived from the features extracted from the captured images. The computing system 205 interacts with UI 272 and the AI system 210 to cause display of the pre-task guidance and/or the task guidance and feedback output on display 270 of the mobile device(s) 262.

In examples, the task guidance and feedback output includes at least one of: (a) a confirmation that the network equipment is consistent with a network equipment identified in the technician task; (b) a confirmation that the network equipment is correctly connected to the network consistent with the technician task; (c) a confirmation that the network equipment is working properly based on computer vision-based analysis; (d) a notification that the network equipment is not consistent with the network equipment identified in the technician task in terms of at least one of type of equipment, model of equipment, or version of equipment; (c) a notification that at least one of a rack, a shelf, a slot, or a port for mounting or connecting the network equipment, based on the technician task, is already being used by another network equipment; (f) a notification that the network equipment is incorrectly connected to the network, the notification including comparison between a correct set of rack, shelf, slot, or port for connecting the network equipment and an actual set of rack, shelf, slot, or port to which the network equipment is currently connected; or (g) a notification that the network equipment is not working properly based on computer vision-based analysis; and/or the like. In some aspects, historical images of the network equipment may be stored and maintained in the image library 215 or long term storage to enable creation (if necessary) of a visual audit trail of chances over time for particular network equipment. In some examples, images of network equipment are taken and stored as proof of work (such as for repair work and/or disputes). In examples, for quality assurance, the AI system compares the images of network equipment after task completion with the task information (or scope of work in the circuit or configuration as designed) to determine whether the task as completed reflects the task as designed, and provides feedback and/or recommendations accordingly.

Turning to the example system 200B of FIG. 2B, an example implementation of AI-assisted image-based network equipment discovery and inventory reconciliation may be as follows. Images of network equipment 260a-260y at location(s) 258 may be captured by mobile device(s) 262 and sent, via UI 272, to image event consumer(s) 256b prior to being image processed by network image processor(s) 254, ingested by ingester 224, and stored in image library 215, as described above with respect to FIGS. 2 and 2A. The AI system 210 uses feature extractor 212 to extract features from the captured images of the network equipment 260a-260y. In examples, the features that are extracted include, for each network equipment having a plurality of components, at least one of a manufacturer, a type, a device name, a device ID, a model number, version information, a capacity, a number of operational components, a number of failed or failing components, a number of used components, or a number of unused components of that network equipment, and/or the like. In some examples, the features may further include a shelf ID for a shelf of an equipment rack on which each network equipment is mounted, rack information for the equipment rack, or slot positions on each shelf used by which network equipment. The AI system 210 uses the GPUs 220a-220p to perform processing for AI/ML tasks utilizing computer vision-based AI models among the AI models 218a-218m, within ML pipelines or workspace 216, to assist the feature extractor 212 in extracting the features described above.

In some examples, the AI system 210 interacts with DnR agent 274, via computing system 205, to retrieve inventory data for the network equipment. Based on a determination as to which inventory equipment (e.g., corresponding to the network equipment) is being searched (at operation 276), an inventory system 228 that contains inventory data for the network equipment is searched by searching the inventory's DnR (corresponding one of inventory DnR 278a-278n) and fetching inventory data for the network equipment from inventory database (corresponding one of inventory database 284a-284n) via corresponding API (e.g., one of APIs 282a-282n) and corresponding inventory adapter (e.g., one of inventory adapters 280a-280n). In some cases, the inventory DnR 278 retrieves DnR data for the network equipment from DnR database 226. The AI system 210 uses the GPUs 220a-220p to perform processing for AI/ML tasks utilizing computer vision-based AI models among the AI models 218a-218m, within ML pipelines or workspace 216, to compare information from the extracted features with corresponding inventory data for the network equipment, in some cases, to determine whether among other feature information, network equipment, network elements, cards, slots, and/or ports, etc. match with corresponding information contained in the inventory data for the network equipment. Any visible discrepancies between the captured images and the inventory data for the network equipment are identified as a result of such comparison and determination. The AI system 210 uses the GPUs 220a-220p to perform processing for AI/ML tasks utilizing generative AI models among the AI models 218a-218m, within ML pipelines or workspace 216, to assist the recommendations AI 214 to produce recommendations (e.g., replacing network equipment, components, connectors, etc.; reconnecting components, etc.; and/or updating/reconciling the inventory system 228 and/or DnR database 226) in the event that visible discrepancies are identified. When updating or reconciling the inventory system(s) 228a-228n, the particular inventory system is selected based on selection of network equipment (at operation 276), and reconciliation is performed between the inventory DnR 278 (which obtains DnR information from DnR database 226) and the inventory database 284 (via API 282 and inventory adaptor 280).

In examples, the AI system 210 uses the GPUs 220a-220p to perform processing for AI/ML tasks utilizing generative AI models among the AI models 218a-218m, within ML pipelines or workspace 216, to assist the recommendations AI 214 to produce a discovery and reconciliation output, in some cases, based on inventory data of network equipment and based on information regarding the plurality of network equipment and regarding where the plurality of network equipment is physically connected to the network as derived from the plurality of features extracted from the plurality of images of the plurality of network equipment. In some examples, the discovery and reconciliation output includes at least one of information regarding which network equipment are connected to the network consistent with the inventory of network equipment, information regarding which network equipment are connected to the network inconsistent with the inventory of network equipment, information regarding missing network equipment, information regarding undocumented network equipment that are connected to the network, or information regarding visible discrepancies between one or more images of at least one network equipment and inventory data for the at least one network equipment, and/or the like. In examples, the computing system 205 causes the discovery and reconciliation output to be displayed in DnR UI 238, which is displayed on a display of user device(s) 230 (e.g., display 136 of user device(s) 130 of FIG. 1).

In some examples, a user(s) 232 (e.g., a network management team member, a network operations team member, a network audit team member, a task manager, a network planning team member, or a field technician, etc.) utilizes a user device(s) 230 to interact with a DnR UI 238 to perform various operations. For example, one operation is a DnR search 238a, which enables the DnR UI 238 to search DnR database(s) 226 using search utility 222. The DnR database(s) 226 and the inventory system(s) 228a-228n are both updated (and, in some cases, at least partially synchronized with respect to corresponding data stored on each type of database system), using computing system 205 and, in some cases, DnR agent 274. In examples, the DnR database 226 stores DnR data, including, but not limited to, schedule information 226a, equipment information 226b, port information 226c, card information 226d, and/or slot information 226e for particular network equipment 260. In some cases, the schedule information 226a may include schedule ID, equipment ID, and schedule data for the network equipment. The equipment information 226b may include equipment ID (which is also reflected in the schedule information 226a), a target ID, model information, version information, and type information for the network equipment. The port information 226c may include port ID, port name, equipment ID (which is also reflected in the schedule information 226a), card ID (which is also reflected in the card information 226d), and port type. The card information 226d may include card ID, slot ID (which is also reflected in the slot information 226c), and card name. The slot information 226c may include slot ID and slot name. The DnR UI 238 also interacts with AI system 210, in some cases, via computing system 205, and enables training of AI model(s) 218 (e.g., using model management-train functionality 238b) and/or testing of AI model(s) 218 (e.g., using model management-test functionality 238c). DnR UI 238 also enables uploading of images (in some cases, in bulk), using DnR image upload functionality 238d, and the uploaded images are ingested by ingester 224, prior to storage in image library 215, from which the AI system 210 accesses images to perform AI/ML tasks (e.g., feature extraction, image analysis, guidance generation, recommendations, etc.) and to perform DnR tasks. In some aspects, the DnR UI 238 displays information including, but not limited to: (1) information regarding discovered equipment; (2) information regarding reconciled information; (3) information regarding failures and/or successes in terms of DnR; (4) information regarding scheduling of DnR tasks for certain equipment types; (5) information regarding disabling DnR; (6) information regarding how users can take further actions based on the results; and/or the like.

With reference to the example system 200C of FIG. 2C, an example implementation of AI-assisted image-based network capacity planning may be as follows. Image capture, processing, storage in image library, and AI system processing (e.g., feature extraction, DnR comparisons, etc.) of images of network equipment 260a-260y are as described in detail above with respect to FIGS. 2, 2A, and/or 2B. Network equipment discovery and reconciliation functions are as described above with respect to FIG. 2B. In examples, a network planner(s) 252 utilizes the network planner device(s) 250 to interact with network planning system 246 and/or network planning drive(s) 248 to send images generated or otherwise outputted by network planning system 246 to the image event consumer(s) 256b. The image event consumer(s) 256b sends images from UI 272 and/or images from network planning system 246 to the network image processor(s) 254 for image processing prior to ingestion by ingester 224 and storage in image library 215. In some cases, the network planning system 246 interacts with computing system 205 to access information stored in the DnR database(s) 226 and/or the inventory system(s) 228a-228n when performing network planning operations.

In some examples, the AI system 210 uses feature extractor 212 to extract features from the captured images of the network equipment 260a-260y. In examples, the features that are extracted include, for each network equipment having a plurality of components, at least one of a type, a model number, a capacity, a number of operational components, a number of failed or failing components, a number of used components, or a number of unused components of that network equipment, and/or the like. In some instances, the features may further include one or more of a number of used equipment racks, a number of unused equipment racks, a number of used shelves on each equipment rack, a number of unused shelves on each equipment rack, a number of used slots on each shelf, or a number of unused slots on each shelf, and/or the like. The AI system 210 uses the GPUs 220a-220p to perform processing for AI/ML tasks utilizing computer vision-based AI models among the AI models 218a-218m, within ML pipelines or workspace 216, to assist the feature extractor 212 in extracting the features described above. The AI system 210 uses the GPUs 220a-220p to perform processing for AI/ML tasks utilizing generative AI models among the AI models 218a-218m, within ML pipelines or workspace 216, to assist the recommendations AI 214 to produce network capacity planning recommendations, in some cases, based on expected or projected network service usage and based on current capacity and current status of operation of the plurality of network equipment derived from the plurality of features extracted from the plurality of images of the plurality of network equipment. In examples, the computing system 205 causes the network capacity planning recommendations to be displayed on a display of the network planner device(s) 250.

In some examples, the computing system 205 and/or the AI system 210 causes ordering of new network equipment and/or causes generation of work orders to deploy and install the new network equipment, based on the network capacity planning recommendations, using the at least one AI model. Alternatively or additionally, in examples, the computing system 205 and/or the AI system 210 causes generation of work orders for one or more of network grooming, reallocation of network equipment, or reassignment of components of network equipment, based on the network capacity planning recommendations, using the at least one AI model.

FIGS. 3A and 3B depict various example user interfaces (“UIs”) 300A and 300B that may be displayed on a mobile device associated with or used by a field technician when implementing AI-assisted image-based field technician task assistance and validation, in accordance with various embodiments. In some embodiments, UIs 372a and 372b of FIGS. 3A and 3B, respectively, may be similar, if not identical, to the UIs 172 or 272, respectively, of system 100 of FIG. 1 or systems 200 and 200A-200C of FIGS. 2 and 2A-2C, and the description of these components of system 100 of FIG. 1 or systems 200 and 200A-200C of FIGS. 2 and 2A-2C are similarly applicable to the corresponding components of FIGS. 3A and 3B.

FIG. 3A depicts an example UI 372a for installation of network equipment. As shown in the non-limited example of FIG. 3A, UI 372a may include options for taking a picture or photograph (i.e., capturing an image(s)) of the network equipment, which may be performed before or during installation of the network equipment (to utilize the AI-assisted image-based task assistance or “Job Assistant” functionalities, as described in detail with respect to FIG. 2A and 4A), or after installation (to utilize “Post Quality Check” functionalities, as also described in detail with respect to FIGS. 2A and 4A). UI 372a may further include a Job Assistant field in which task information, navigation information, step-by-step task guidance information, and/or access guidance images (as described above with respect to FIGS. 2A) may be displayed. As described above, the step-by-step task guidance information may include at least one of image-based guidance, audio-based guidance, video-based guidance, text-based guidance, or text-to-speech-based guidance for performing the technician task, and/or the like. In some cases, at least one image contained in the image-based guidance or the video-based guidance may be based on at least one of one or more previously captured images of the network equipment, one or more stock images of network equipment that are of a same type or model as the network equipment, or an AI-generated mock image of network equipment that is similar to the network equipment, and/or the like. The UI 372a may further include options to continue with or cancel the Job Assistant function. The UI 372a may further include options to Confirm Work on the installation, as described above with respect to the tack guidance and feedback output. Although UI 372a is directed to installation, UI 372a may also be configured to provide AI-assisted image-based technician assistance for other technician tasks, including, but not limited to, provisioning, decommissioning, grooming, maintenance, troubleshooting, or repair, and/or the like. UI 372a may further include options to provide feedback to improve the AI-assisted image-based technician assistance.

FIG. 3B depicts an example UI 372b for performing a site survey. As shown in the non-limited example of FIG. 3B, UI 372b may include options for uploading pictures or photographs (i.e., uploading captured images) of the network equipment for equipment discovery and reconciliation that is performed by the computing system 205, the AI system 210, the DnR agent 274, the DnR database 226, and the inventory system(s) 228a-228n (utilizing components 276, 278a-278n, 280a-280n, 282a-282n, and 284a-284n), as described in detail above with respect to FIG. 2B. UI 372b may further include a Discovery & Reconciliation field in which may be displayed inventory data for the network equipment and/or AI-identified visible discrepancies (if any). Alternatively or additionally, in the event that visible discrepancies are identified, Ai-generated recommendations (e.g., replacing network equipment, components, connectors, etc.; reconnecting components, etc.; and/or updating/reconciling the inventory system 228 and/or DnR database 226) may be displayed in the Discovery & Reconciliation field. The UI 372b may further include options to continue with or cancel the Discovery & Reconciliation function. The UI 372b may further include options to “Sync with Inventory,” which causes synchronization between the uploaded images and the DnR database and/or the inventory system(s), as described above with respect to FIG. 2B. Although UI 372b is directed to site surveys, UI 372b may also be configured to provide AI-assisted image-based technician assistance for other technician tasks, including, but not limited to, equipment audits, DnR tasks, and/or the like. UI 372b may further include options to provide feedback to improve the AI-assisted image-based technician assistance.

With reference to FIGS. 4 and 4A-4C, the operations of example methods 400 and 400A-400C may be performed by a computing system (e.g., computing system 105 or 205 of FIGS. 1, 2, and 2A-2C). Referring to FIGS. 5A and 5B, the operations of example method 500 may be performed by a computing system (e.g., computing system 105 or 205 of FIGS. 1, 2, and 2A-2C), while the operations of example method 500 of FIG. 5C may be performed by a mobile device and/or a software application running on the mobile device (e.g., mobile device 162 or 262 of FIGS. 1, 2, and 2A-2C).

FIG. 4 depicts a flow diagram illustrating an example method 400 for implementing AI-assisted image-based network management, operations, maintenance, planning, and deployment, in accordance with various embodiments. FIG. 4A depicts a flow diagram illustrating an example method for implementing AI-assisted image-based field technician task assistance, in accordance with various embodiments. FIG. 4B depicts a flow diagram illustrating an example method for implementing AI-assisted image-based discovery and reconciliation of network equipment, in accordance with various embodiments. FIG. 4C depicts a flow diagram illustrating an example method for implementing AI-assisted image-based network planning and design, in accordance with various embodiments.

In the non-limiting embodiment of FIG. 4, method 400, at operation 402, may include a computing system accessing at least one first image of a first network equipment (e.g., one of network equipment 160a-160y or 260a-260y of FIGS. 1, 2, and 2A-2C) that is used to provide network services in a network (e.g., network(s) 174 of FIG. 1). The at least one first image is captured at a first location (e.g., location 158 or 258 of FIGS. 1, 2, and 2A-2C) where the first network equipment is physically connected to the network. At operation 404, the computing system causes extraction of one or more first features from the at least one first image, using at least one AI model (e.g., AI model(s) 118a-118m or 218a-218m of FIGS. 1, 2, and 2A-2C) of an AI system (e.g., AI system 110 or 210 of FIGS. 1, 2, and 2A-2C). The at least one AI model is trained to perform computer vision tasks on an equipment type corresponding to the first network equipment. In an example, causing extraction of one or more first features from the at least one first image (at operation 404) includes the computing system sending, to the AI system, instructions for a first AI model among the at least one AI model to extract the one or more first features (at operation 406), where the first AI model is a computer vision-based neural network model. Alternatively, in another example, causing extraction of one or more first features from the at least one first image (at operation 404) includes the computing system sending, to the AI system, a prompt for a second AI model among the at least one AI model to output the one or more first features from the at least one first image (at operation 408), where the second AI model is a large language model (“LLM”) that is capable of vision-processing tasks.

In examples, the computing system includes one of a DnR computing system, a task management system, a network planning and design computing system, a NOC computing system, a network service provisioning system, a technician task assistance system, a network maintenance and troubleshooting system, a network security system, a network image processing system, a system orchestrator, a server, a cloud computing system, or a distributed computing system, and/or the like. In some cases, the first location is one of a data center, a central office, a field location, or a customer premises, and/or the like. In some examples, the at least one AI model includes one or more first AI models trained to perform the computer vision tasks and one or more second AI models trained to generate outputs related to the first network-based tasks.

At operation 410, the computing system causes generation of an output related to a first network-based task to be performed on at least one of the first network equipment or the network to which the first network equipment is connected, using the at least one AI model. At operation 412, the computing system causes display of the output on a display device of a user device associated with (or used by) a first entity (e.g., display 170 or 270 of mobile device 162 or 262 that is associated with or used by a technician 164 or 264 of FIGS. 1 and 2A; or display 136 of user device 130 that is associated with or used by a user 132 of FIG. 1).

Turning to example method 400A of FIG. 4A, which is directed to implementing AI-assisted image-based field technician task assistance, at operation 414, the computing system receives one or more first images of the first network equipment that are captured and uploaded using the mobile device. Alternatively or additionally, at operation 416, the computing system retrieves one or more second images of the first network equipment from an image library (e.g., image library 115 or 215 of FIGS. 1, 2, and 2A-2C). At operation 418, the computing system causes extraction of one or more first features from at least one of the one or more first images or the one or more second images that are obtained from the image library, using the at least one AI model of the AI system. At operation 420, the computing system causes generation of a task guidance and feedback output, using the at least one AI model of the AI system, based on a first technician task to be performed on a first network equipment by the field technician and based on information regarding the first network equipment and regarding where the first network equipment is physically connected to the network as derived from the one or more first features extracted from the at least one first image. At operation 422, the computing system causes display of the task guidance and feedback output on a display device of the mobile device associated with the field technician.

In some examples, the first network equipment has a plurality of components, including at least one of slots, ports, or connectors. In examples, the one or more first features that are extracted from the at least one first image include at least one of a manufacturer, a type, a device name, a device ID, a model number, version information, a capacity, a number of operational components, a number of failed or failing components, a number of used components, or a number of unused components of the first network equipment, and/or the like. In some cases, the one or more first features further includes one or more of a shelf ID for a shelf of an equipment rack on which the first network equipment is mounted, rack information for the equipment rack, a slot position on the shelf that is being used by the first network equipment, or other slot positions on the shelf that are being used by other network equipment, and/or the like.

In examples, the task guidance and feedback output includes at least one of:
(a) a confirmation that the first network equipment is consistent with a network equipment identified in the first technician task;
(b) a confirmation that the first network equipment is correctly connected to the network consistent with the first technician task;
(c) a confirmation that the first network equipment is working properly based on computer vision-based analysis;
(d) a notification that the first network equipment is not consistent with the network equipment identified in the first technician task in terms of at least one of type of equipment, model of equipment, or version of equipment;
(e) a notification that at least one of a rack, a shelf, a slot, or a port for mounting or connecting the first network equipment, based on the first technician task, is already being used by another network equipment;
(f) a notification that the first network equipment is incorrectly connected to the network, the notification including comparison between a correct set of rack, shelf, slot, or port for connecting the first network equipment and an actual set of rack, shelf, slot, or port to which the first network equipment is currently connected; or
(g) a notification that the first network equipment is not working properly based on computer vision-based analysis.

Referring to example method 400B of FIG. 4B, which is directed to implementing AI-assisted image-based discovery and reconciliation of network equipment, at operation 424, the computing system compiles and maintains an image library (e.g., image library 115 or 215 of FIGS. 1, 2, and 2A-2C) containing a plurality of images of a plurality of network equipment (e.g., the plurality of network equipment 160a-160y or 260a-260y of FIGS. 1, 2, and 2A-2C) that is used to provision network services in the network, where the plurality of network equipment includes the first network equipment. In examples, the image library contains at least one of:
(1) images of one or more network equipment that are captured and uploaded by field technicians during truck rolls;
(2) images of one or more network equipment that are captured and uploaded by field technicians during site surveys;
(3) images of one or more network equipment that are captured and uploaded by field technicians during maintenance, troubleshooting, or repair operations;
(4) images of one or more network equipment that are captured and uploaded by field technicians during network equipment installation, provisioning, decommissioning, or grooming operations;
(5) images of one or more network equipment that are captured and uploaded by field technicians during equipment audits; or
(6) images of one or more network equipment that are uploaded from one or more data storage systems by service provider agents.

At operation 426, the computing system causes extraction of a plurality of features from images of the plurality of network equipment obtained from the image library, using the at least one AI model of the AI system. At operation 428, the computing system causes generation of a discovery and reconciliation output, using the at least one AI model, based on an inventory of network equipment and based on information regarding the plurality of network equipment and regarding where the plurality of network equipment is physically connected to the network as derived from the plurality of features extracted from the plurality of images of the plurality of network equipment. At operation 430, the computing system causes display of the discovery and reconciliation output on the display device of the user device associated with the first entity.

In some examples, the discovery and reconciliation output includes at least one of information regarding which network equipment are connected to the network consistent with the inventory of network equipment, information regarding which network equipment are connected to the network inconsistent with the inventory of network equipment, information regarding missing network equipment, information regarding undocumented network equipment that are connected to the network, or information regarding visible discrepancies between one or more images of at least one network equipment and inventory data for the at least one network equipment, and/or the like. In examples, the first entity includes one of a network management team member, a network operations team member, a network audit team member, a task manager, a network planning team member, or a field technician, and/or the like.

In examples, the plurality of features includes, for each network equipment having a plurality of components, at least one of a manufacturer, a type, a device name, a device ID, a model number, version information, a capacity, a number of operational components, a number of failed or failing components, a number of used components, or a number of unused components of that network equipment, and/or the like. In some cases, the plurality of components includes at least one of slots, ports, or connectors, and/or the like. In some examples, the plurality of features further includes a shelf ID for a shelf of an equipment rack on which each network equipment is mounted, rack information for the equipment rack, or slot positions on each shelf used by which network equipment, and/or the like.

With reference to example method 400C of FIG. 4C, which is directed to implementing AI-assisted image-based network planning and design, at operation 432 (similar to operation 424 of FIG. 4B), the computing system compiles and maintains an image library containing a plurality of images of a plurality of network equipment that is used to provision network services in the network, where the plurality of network equipment includes the first network equipment. At operation 434, the computing system causes extraction of a plurality of features from images of the plurality of network equipment obtained from the image library, using the at least one AI model of the AI system. At operation 436, the computing system causes generation of network capacity planning recommendations, using the at least one AI model, based on expected or projected network service usage and based on current capacity and current status of operation of the plurality of network equipment derived from the plurality of features extracted from the plurality of images of the plurality of network equipment. At operation 438, the computing system causes display of the network capacity planning recommendations on the display device of the user device associated with the first entity, where the first entity includes a network planning team member.

Method 400C either continues onto the process at operation 440 and/or continues onto the process at operation 442. At operation 440, the computing system causes ordering of new network equipment and generating work orders to deploy and install the new network equipment, based on the network capacity planning recommendations, using the at least one AI model. Alternatively or additionally, at operation 442, the computing system causes generation of work orders for one or more of networking grooming, reallocation of network equipment, or reassignment of components of network equipment, based on the network capacity planning recommendations, using the at least one AI model.

In examples, the plurality of features includes, for each network equipment having a plurality of components, at least one of a type, a model number, a capacity, a number of operational components, a number of failed or failing components, a number of used components, or a number of unused components of that network equipment, and/or the like. In some cases, the plurality of components includes at least one of slots, ports, or connectors, and/or the like. In some examples, the plurality of features further includes one or more of a number of used equipment racks, a number of unused equipment racks, a number of used shelves on each equipment rack, a number of unused shelves on each equipment rack, a number of used slots on each shelf, a number of unused slots on each shelf, and/or the like.

FIGS. 5A-5C depict flow diagrams illustrating an example method for implementing AI-assisted image-based field technician task assistance and validation, in accordance with various embodiments. Method 500 of FIG. 5B continues onto FIG. 5A following the circular marker denoted, “A.”

In the non-limiting embodiment of FIG. 5A, method 500, at operation 505, may include a computing system sending, to a first mobile device associated with a first technician, first instructions that cause the first mobile device to display, on a display device of the first mobile device, first information associated with a first technician task to be performed on a first network equipment by the first technician. At operation 510, the computing system receives, from the first mobile device, one or more images of the first network equipment that are captured and uploaded via the first mobile device. At operation 515, the computing system causes computer vision processing, using at least one AI model of an AI system, to identify one or more features in the one or more images of the first network equipment. At operation 520, the computing system causes generation of a task guidance and feedback output based on the first technician task to be performed on a first network equipment by the first technician and based on information regarding the first network equipment and regarding where the first network equipment is physically connected to a network as derived from the one or more first features extracted from the one or more images, using the at least one AI model. At operation 525, the computing system causes display of the task guidance and feedback output on the display device of the first mobile device associated with the first technician.

In examples, the computing system includes one of a task management system, a NOC computing system, a network service provisioning system, a network technician task assistance system, a network maintenance and troubleshooting system, a server, a cloud computing system, or a distributed computing system, and/or the like. In some examples, the first information is one of: (i) already downloaded on a local memory of the first mobile device; (ii) sent to the first mobile device together with sending of the first instructions; or (iii) sent to the first mobile device separate from sending of the first instructions. In some instances, the first information includes at least one of: (A) task information associated with performing the first technician task; (B) navigation information to guide the first technician to a location of the first network equipment; (C) step-by-step task guidance information including at least one of image-based guidance, audio-based guidance, video-based guidance, text-based guidance, or text-to-speech-based guidance for performing the first technician task, and/or the like; or (D) one or more access guidance images for accessing one or more portions of the first network equipment prior to performing the first technician task; and/or the like. In some cases, at least one image contained in the image-based guidance or the video-based guidance may be based on at least one of one or more previously captured images of the first network equipment, one or more stock images of network equipment that are of a same type or model as the first network equipment, or an AI-generated mock image of network equipment that is similar to the first network equipment, and/or the like.

With reference to FIG. 5B, in an example, method 500 includes the computing system generating the task information (at operation 530), and sending the task information to the first mobile device for display on a display device of the first mobile device (at operation 535). Method 500 continues onto the process at operation 505 in FIG. 5A following the circular marker denoted, “A.” Alternatively or additionally, in another example, method 500 includes the computing system causing a navigation system to generate the navigation information (at operation 540), and sending the navigation information to the first mobile device for display on the display device of the first mobile device (at operation 545). Method 500 continues onto the process at operation 505 in FIG. 5A following the circular marker denoted, “A.” Alternatively or additionally, in yet another example, method 500 includes the computing system causing an AI system to generate the step-by-step task guidance information (at operation 550), and sending the step-by-step task guidance information to the first mobile device for display on the display device of the first mobile device (at operation 555). Method 500 continues onto the process at operation 505 in FIG. 5A following the circular marker denoted, “A.” Alternatively or additionally, in still another example, method 500 includes the computing system causing the AI system to generate the one or more access guidance images (at operation 560), and sending the one or more access guidance images to the first mobile device for display on the display device of the first mobile device (at operation 565). Method 500 continues onto the process at operation 505 in FIG. 5A following the circular marker denoted, “A.”

In some examples, the one or more features identified in the one or more images of the first network equipment includes one or more of manufacturer information; an equipment type; a device name; a device ID; a device model; a device version; a device capacity; components of the first network equipment that are currently being used, the components including at least one of slots, ports, connectors; components of the first network equipment that are currently unused; components of the first network equipment that are determined to be operational; components of the first network equipment that are determined to be damaged or non-operational; indicator lights indicating operational status of components of the first network equipment; a shelf ID for a shelf of an equipment rack on which the first network equipment is mounted; rack information for the equipment rack; a slot position on the shelf that is being used by the first network equipment; or other slot positions on the shelf that are being used by other network equipment; and/or the like.

Referring to FIG. 5C, in some examples, the first mobile device receives the first instructions via a first software application running on the first mobile device. At operation 570, the first software application causes the first mobile device to display, in a UI on a display device of the first mobile device, the first information. At operation 575, the first software application causes the first mobile device to prompt the first technician, via the UI, to capture and upload the one or more images of the first network equipment. At operation 580, the first software application causes the first mobile device to capture and upload, via the UI, the one or more images of the first network equipment in response to user input by the first technician. At operation 585, the first software application causes the first mobile device to receive, via the first software application, the task guidance and feedback output. At operation 590, the first software application causes the first mobile device to display, via the UI, the task guidance and feedback output.

In examples, the task guidance and feedback output includes at least one of:
(a) a confirmation that the first network equipment is consistent with a network equipment identified in the first technician task;
(b) a confirmation that the first network equipment is correctly connected to the network consistent with the first technician task;
(c) a confirmation that the first network equipment is working properly based on computer vision-based analysis;
(d) a notification that the first network equipment is not consistent with the network equipment identified in the first technician task in terms of at least one of type of equipment, model of equipment, or version of equipment;
(c) a notification that at least one of a rack, a shelf, a slot, or a port for mounting or connecting the first network equipment, based on the first technician task, is already being used by another network equipment;
(f) a notification that the first network equipment is incorrectly connected to the network, the notification including comparison between a correct set of rack, shelf, slot, or port for connecting the first network equipment and an actual set of rack, shelf, slot, or port to which the first network equipment is currently connected; or
(g) a notification that the first network equipment is not working properly based on computer vision-based analysis.

While the techniques and procedures in methods 400, 400A, 400B, 400C, and 500 are depicted and/or described in a certain order for purposes of illustration, it should be appreciated that certain procedures may be reordered and/or omitted within the scope of various embodiments. Moreover, while the methods 400, 400A, 400B, 400C, and 500 may be implemented by or with (and, in some cases, are described below with respect to) the systems, examples, or embodiments 100, 200, 200A, 200B, 200C, 300A and 300B of FIGS. 1, 2, 2A, 2B, 2C, 3A, and 3B, respectively (or components thereof), such methods may also be implemented using any suitable hardware (or software) implementation. Similarly, while each of the systems, examples, or embodiments 100, 200, 200A, 200B, 200C, 300A and 300B of FIGS. 1, 2, 2A, 2B, 2C, 3A, and 3B, respectively (or components thereof), can operate according to the methods 400, 400A, 400B, 400C, and 500 (e.g., by executing instructions embodied on a computer readable medium), the systems, examples, or embodiments 100, 200, 200A, 200B, 200C, 300A and 300B of FIGS. 1, 2, 2A, 2B, 2C, 3A, and 3B can each also operate according to other modes of operation and/or perform other suitable procedures.

### Exemplary System and Hardware Implementation

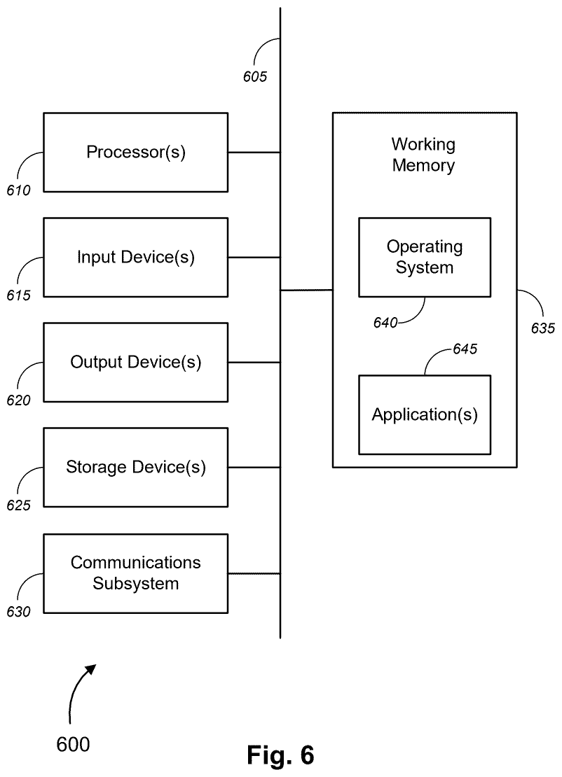

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., computing systems 105 and 205, AI systems 110 and 210, inventory systems 128a-128n and 228a-228n, user devices 130 and 230, task management systems 140 and 240, task manager devices 142 and 242, network planning systems 146 and 246, network planner devices 150 and 250, network image processors 154 and 254, network equipment 160a-160y and 260a-260y, and mobile devices 162 and 262, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600-which might represent an embodiment of the computer or hardware system (i.e., computing systems 105 and 205, AI systems 110 and 210, inventory systems 128a-128n and 228a-228n, user devices 130 and 230, task management systems 140 and 240, task manager devices 142 and 242, network planning systems 146 and 246, network planner devices 150 and 250, network image processors 154 and 254, network equipment 160a-160y and 260a-260y, and mobile devices 162 and 262, etc.), described above with respect to FIGS. 1-5C—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for case of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for case of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
accessing, by a computing system, at least one first image of a first network equipment that is used to provide network services in a network, the at least one first image being captured at a first location where the first network equipment is physically connected to the network;
causing, by the computing system, extraction of one or more first features from the at least one first image, using at least one artificial intelligence (“AI”) model of an AI system, the at least one AI model being trained to perform computer vision tasks on an equipment type corresponding to the first network equipment;
causing, by the computing system, generation of an output related to a first network-based task to be performed on at least one of the first network equipment or the network to which the first network equipment is connected, using the at least one AI model; and
causing, by the computing system, display of the output on a display device of a user device associated with a first entity.

2. The method of claim 1, wherein the computing system includes one of a discovery and reconciliation (“DnR”) computing system, a task management system, a network planning and design computing system, a network operations center (“NOC”) computing system, a network service provisioning system, a technician task assistance system, a network maintenance and troubleshooting system, a network security system, a network image processing system, a system orchestrator, a server, a cloud computing system, or a distributed computing system, wherein the first location is one of a data center, a central office, a field location, or a customer premises.

3. The method of claim 1, wherein the at least one AI model includes one or more first AI models trained to perform the computer vision tasks and one or more second AI models trained to generate outputs related to the first network-based tasks.

4. The method of claim 1, wherein causing the extraction of the one or more first features from the at least one first image comprises one of:
sending, by the computing system and to the AI system, instructions for a first AI model among the at least one AI model to extract the one or more first features, wherein the first AI model is a computer vision-based neural network model; or
sending, by the computing system and to the AI system, a prompt for a second AI model among the at least one AI model to output the one or more first features from the at least one first image, wherein the second AI model is a large language model (“LLM”) that is capable of vision-processing tasks.

5. The method of claim 1, further comprising:
compiling and maintaining, by the computing system, an image library containing a plurality of images of a plurality of network equipment that is used to provision network services in the network, wherein the plurality of network equipment includes the first network equipment.

6. The method of claim 5, wherein the image library contains at least one of:
images of one or more network equipment that are captured and uploaded by field technicians during truck rolls;
images of one or more network equipment that are captured and uploaded by field technicians during site surveys;
images of one or more network equipment that are captured and uploaded by field technicians during maintenance, troubleshooting, or repair operations;
images of one or more network equipment that are captured and uploaded by field technicians during network equipment installation, provisioning, decommissioning, or grooming operations;
images of one or more network equipment that are captured and uploaded by field technicians during equipment audits; or
images of one or more network equipment that are uploaded from one or more data storage systems by service provider agents.

7. The method of claim 5, wherein the first network-based task includes discovery and reconciliation of network equipment based on the image library of the plurality of network equipment that is used to provision network services in the network,
wherein causing the extraction of the one or more first features from the at least one first image comprises causing, by the computing system, extraction of a plurality of features from images of the plurality of network equipment obtained from the image library, using the at least one AI model of the AI system;
wherein causing the generation of the output related to the first network-based task comprises causing, by the computing system, generation of a discovery and reconciliation output, using the at least one AI model, based on an inventory of network equipment and based on information regarding the plurality of network equipment and regarding where the plurality of network equipment is physically connected to the network as derived from the plurality of features extracted from the plurality of images of the plurality of network equipment;
wherein the discovery and reconciliation output includes at least one of information regarding which network equipment are connected to the network consistent with the inventory of network equipment, information regarding which network equipment are connected to the network inconsistent with the inventory of network equipment, information regarding missing network equipment, information regarding undocumented network equipment that are connected to the network, or information regarding visible discrepancies between one or more images of at least one network equipment and inventory data for the at least one network equipment; and
wherein causing the display of the output comprises causing, by the computing system, display of the discovery and reconciliation output on the display device of the user device associated with the first entity, wherein the first entity includes one of a network management team member, a network operations team member, a network audit team member, a task manager, a network planning team member, or a field technician.

8. The method of claim 7, wherein the plurality of features includes, for each network equipment having a plurality of components, at least one of a manufacturer, a type, a device name, a device identifier (“ID”), a model number, version information, a capacity, a number of operational components, a number of failed or failing components, a number of used components, or a number of unused components of that network equipment, wherein the plurality of components includes at least one of slots, ports, or connectors, wherein the plurality of features further includes a shelf ID for a shelf of an equipment rack on which each network equipment is mounted, rack information for the equipment rack, or slot positions on each shelf used by which network equipment.

9. The method of claim 5, wherein the first network-based task includes network planning and design based on the image library of the plurality of network equipment that is used to provision network services in the network,
wherein causing the extraction of the one or more first features from the at least one first image comprises causing, by the computing system, extraction of a plurality of features from images of the plurality of network equipment obtained from the image library, using the at least one AI model of the AI system;
wherein causing the generation of the output related to the first network-based task comprises causing, by the computing system, generation of network capacity planning recommendations, using the at least one AI model, based on expected or projected network service usage and based on current capacity and current status of operation of the plurality of network equipment derived from the plurality of features extracted from the plurality of images of the plurality of network equipment; and
wherein causing the display of the output comprises causing, by the computing system, display of the network capacity planning recommendations on the display device of the user device associated with the first entity, wherein the first entity includes a network planning team member.

10. The method of claim 9, further comprising at least one of:
causing, by the computing system, ordering of new network equipment and generating work orders to deploy and install the new network equipment, based on the network capacity planning recommendations, using the at least one AI model; or
causing, by the computing system, generation of work orders for one or more of networking grooming, reallocation of network equipment, or reassignment of components of network equipment, based on the network capacity planning recommendations, using the at least one AI model.

11. The method of claim 9, wherein the plurality of features includes, for each network equipment having a plurality of components, at least one of a type, a model number, a capacity, a number of operational components, a number of failed or failing components, a number of used components, or a number of unused components of that network equipment, wherein the plurality of components includes at least one of slots, ports, or connectors, wherein the plurality of features further includes one or more of a number of used equipment racks, a number of unused equipment racks, a number of used shelves on each equipment rack, a number of unused shelves on each equipment rack, a number of used slots on each shelf, or a number of unused slots on each shelf.

12. The method of claim 5, wherein the first network-based task includes field technician task assistance, wherein the first entity is a field technician, wherein the user device is a mobile device associated with the field technician,
wherein accessing the at least one first image comprises at least one of receiving one or more first images of the first network equipment that are captured and uploaded using the mobile device or retrieving one or more second images of the first network equipment from the image library;
wherein causing the extraction of the one or more first features from the at least one first image comprises causing, by the computing system, extraction of one or more first features from at least one of the one or more first images or the one or more second images that are obtained from the image library, using the at least one AI model of the AI system;
wherein causing the generation of the output related to the first network-based task comprises causing, by the computing system, generation of a task guidance and feedback output based on a first technician task to be performed on a first network equipment by the field technician and based on information regarding the first network equipment and regarding where the first network equipment is physically connected to the network as derived from the one or more first features extracted from the at least one first image; and
wherein causing the display of the output comprises causing, by the computing system, display of the task guidance and feedback output on a display device of the mobile device associated with the field technician.

13. The method of claim 12, wherein the first network equipment has a plurality of components, wherein the plurality of components includes at least one of slots, ports, or connectors, wherein the one or more first features that are extracted from the at least one first image include at least one of a manufacturer, a type, a device name, a device ID, a model number, version information, a capacity, a number of operational components, a number of failed or failing components, a number of used components, or a number of unused components of the first network equipment, wherein the one or more first features further includes one or more of a shelf ID for a shelf of an equipment rack on which the first network equipment is mounted, rack information for the equipment rack, a slot position on the shelf that is being used by the first network equipment, or other slot positions on the shelf that are being used by other network equipment, and
wherein the task guidance and feedback output includes at least one of:
a confirmation that the first network equipment is consistent with a network equipment identified in the first technician task;
a confirmation that the first network equipment is correctly connected to the network consistent with the first technician task;
a confirmation that the first network equipment is working properly based on computer vision-based analysis;
a notification that the first network equipment is not consistent with the network equipment identified in the first technician task in terms of at least one of type of equipment, model of equipment, or version of equipment;
a notification that at least one of a rack, a shelf, a slot, or a port for mounting or connecting the first network equipment, based on the first technician task, is already being used by another network equipment;
a notification that the first network equipment is incorrectly connected to the network, the notification including comparison between a correct set of rack, shelf, slot, or port for connecting the first network equipment and an actual set of rack, shelf, slot, or port to which the first network equipment is currently connected; or
a notification that the first network equipment is not working properly based on computer vision-based analysis.

14. A system, comprising:
an artificial intelligence (“AI”) system includes at least one first AI model trained to perform computer vision tasks and at least one second AI model trained to generate outputs related to network-based tasks; and
a computing system, comprising:
a processing system; and
memory coupled to the processing system, the memory comprising computer executable instructions that, when executed by the processing system, causes the system to perform operations comprising:
accessing at least one first image of a first network equipment that is used to provide network services in a network, the at least one first image being captured at a first location where the first network equipment is physically connected to the network;
causing extraction of one or more first features from the at least one first image, using the at least one first AI model of the AI system, the at least one first AI model each being trained to perform computer vision tasks on an equipment type corresponding to the first network equipment;
causing generation of an output related to a first network-based task to be performed on at least one of the first network equipment or the network to which the first network equipment is connected, using the at least one second AI model; and
causing display of the output on a display device of a user device associated with a first entity.

15. A method, comprising:
sending, by a computing system and to a first mobile device associated with a first technician, first instructions that cause the first mobile device to display, on a display device of the first mobile device, first information associated with a first technician task to be performed on a first network equipment by the first technician;
receiving, by the computing system and from the first mobile device, one or more images of the first network equipment that are captured and uploaded via the first mobile device;
causing, by the computing system, computer vision processing, using at least one artificial intelligence (“AI”) model of an AI system, to identify one or more features in the one or more images of the first network equipment;
causing, by the computing system, generation of a task guidance and feedback output based on the first technician task to be performed on a first network equipment by the first technician and based on information regarding the first network equipment and regarding where the first network equipment is physically connected to a network as derived from the one or more first features extracted from the one or more images, using the at least one AI model; and
causing, by the computing system, display of the task guidance and feedback output on the display device of the first mobile device associated with the first technician.

16. The method of claim 15, wherein the computing system includes one of a task management system, a network operations center (“NOC”) computing system, a network service provisioning system, a network technician task assistance system, a network maintenance and troubleshooting system, a system orchestrator, a server, a cloud computing system, or a distributed computing system.

17. The method of claim 15,
wherein the first information is one of:
already downloaded on a local memory of the first mobile device;
sent to the first mobile device together with sending of the first instructions; or
sent to the first mobile device separate from sending of the first instructions; and
wherein the first information includes at least one of:
task information associated with performing the first technician task;
navigation information to guide the first technician to a location of the first network equipment;
step-by-step task guidance information including at least one of image-based guidance, audio-based guidance, video-based guidance, text-based guidance, or text-to-speech-based guidance for performing the first technician task, wherein at least one image contained in the image-based guidance or the video-based guidance is based on at least one of one or more previously captured images of the first network equipment, one or more stock images of network equipment that are of a same type or model as the first network equipment, or an AI-generated mock image of network equipment that is similar to the first network equipment; or
one or more access guidance images for accessing one or more portions of the first network equipment prior to performing the first technician task.

18. The method of claim 17, further comprising corresponding at least one of:
generating, by the computing system, the task information, and sending, by the computing system, the task information to the first mobile device for display on a display device of the first mobile device;
causing, by the computing system, a navigation system to generate the navigation information, and sending, by the computing system, the navigation information to the first mobile device for display on the display device of the first mobile device;
causing, by the computing system, an AI system to generate the step-by-step task guidance information, and sending, by the computing system, the step-by-step task guidance information to the first mobile device for display on the display device of the first mobile device; or
causing, by the computing system, the AI system to generate the one or more access guidance images, and sending, by the computing system, the one or more access guidance images to the first mobile device for display on the display device of the first mobile device.

19. The method of claim 15, wherein the first mobile device receives the first instructions via a first software application running on the first mobile device, the first software application causing the first mobile device to perform first operations including:
displaying, in a user interface (“UI”) on a display device of the first mobile device, the first information;
prompting the first technician, via the UI, to capture and upload the one or more images of the first network equipment;
capturing and uploading, via the UI, the one or more images of the first network equipment in response to user input by the first technician;
receiving, via the first software application, the task guidance and feedback output; and
displaying, via the UI, the task guidance and feedback output.

20. The method of claim 15, wherein the one or more features identified in the one or more images of the first network equipment includes one or more of:
manufacturer information;
an equipment type;
a device name;
a device ID;
a device model;
a device version;
a device capacity;
components of the first network equipment that are currently being used, the components including at least one of slots, ports, connectors;
components of the first network equipment that are currently unused;
components of the first network equipment that are determined to be operational;
components of the first network equipment that are determined to be damaged or non-operational;
indicator lights indicating operational status of components of the first network equipment;
a shelf ID for a shelf of an equipment rack on which the first network equipment is mounted;
rack information for the equipment rack;
a slot position on the shelf that is being used by the first network equipment; or other slot positions on the shelf that are being used by other network equipment.

21. The method of claim 15, wherein the task guidance and feedback output includes at least one of:
a confirmation that the first network equipment is consistent with a network equipment identified in the first technician task;
a confirmation that the first network equipment is correctly connected to the network consistent with the first technician task;
a confirmation that the first network equipment is working properly based on computer vision-based analysis;
a notification that the first network equipment is not consistent with the network equipment identified in the first technician task in terms of at least one of type of equipment, model of equipment, or version of equipment;
a notification that at least one of a rack, a shelf, a slot, or a port for mounting or connecting the first network equipment, based on the first technician task, is already being used by another network equipment;
a notification that the first network equipment is incorrectly connected to the network, the notification including comparison between a correct set of rack, shelf, slot, or port for connecting the first network equipment and an actual set of rack, shelf, slot, or port to which the first network equipment is currently connected; or
a notification that the first network equipment is not working properly based on computer vision-based analysis.
